(19) United States
(12) Patent Application Publication
(10) Pub. No.: US 2026/0096517 A1
(43) Pub. Date: Apr. 9, 2026

(54) KNOTTER ARMATURE TIE TRIP

(71) Applicant: AGCO Corporation, Duluth, GA (US)

(72) Inventors: James Michael Davis, Hesston, KS (US); Eric Wane Bolton, Hesston, KS (US); Eric John Herbers, Hesston, KS (US); Cale Jared McCabe, Hesston, KS (US)

(21) Appl. No.: 19/349,005

(22) Filed: Oct. 3, 2025

Related U.S. Application Data
(60) Provisional application No. 63/703,948, filed on Oct. 5, 2024.

(51) Int. Cl. A01F 15/14

(52) U.S. Cl. CPC A01F 15/145

(57) ABSTRACT

An agricultural baler includes a drive shaft, a clutch, and a tie trip mechanism. The clutch is shiftable between an engaged condition and a disengaged condition with the drive shaft. The tie trip mechanism includes a trip cam assembly and a trip arm assembly. The trip cam assembly is shiftable between a metering condition associated with the clutch disengaged condition and a tripped condition. The trip arm assembly includes a meter cam leg, a knotter armature rotatable relative to the meter cam leg between a coupled condition and a decoupled condition, and an interference mechanism. The interference mechanism is shiftable between interference and release positions. The interference mechanism shifts the knotter armature to the decoupled condition when in the release position. The knotter armature shifts the clutch to the engaged condition when the knotter armature is in the decoupled condition and the trip cam assembly is in the metering condition.

### CROSS-REFERENCE TO RELATED APPLICATIONS

This application claims the benefit of the filing date of U. S. Provisional Patent Application 63/703948, “KNOTTER ARMATURE TIE TRIP,” filed October 5, 2024, the entire disclosure of which is incorporated herein by reference.

### BACKGROUND

The present invention relates generally to agricultural baling equipment. More specifically, embodiments of the present invention concern a baler with a tie trip mechanism operable to selectively initiate a bale tie cycle on command, irrespective of the position of the trip cam, which generally triggers the bale tie cycle only when in a tripped position.

Powered agricultural balers are commonly used to bind severed hay material and other severed crop material into bales for later use, such as feed for livestock. Square balers that use discrete lengths of twine (or other strands of binding material) to bind loose material into a bale generally include a needle assembly to wrap strands of twine around each formed bale and secure the twine. Prior art balers also generally include a trip mechanism to initiate a bale tie cycle during which the needle assembly is operated to wrap and tie the bale.

The bale tie cycle determines the final length of the bale. The bale tie cycle is initiated at the end of adding a flake of crop material to the bale being formed in the baler. It is often the case in the course of making the bales from quantized flakes of crop, that a desired length of a bale is closer to a certain flake count n than n+1. This is a quantization error that always rounds up, which will make the average bale too long.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, an agricultural baler is provided. The baler includes a drive shaft, a clutch, and a tie trip mechanism. The clutch is shiftable between an engaged condition in which the clutch drivingly interconnects to the drive shaft, and a disengaged condition in which the clutch is drivingly disengaged from the drive shaft. The tie trip mechanism includes a trip cam assembly and a trip arm assembly coupled thereto. The trip cam assembly is shiftable between a metering condition associated with the disengaged condition of the clutch and a tripped condition associated with the engaged condition of the clutch. The trip arm assembly includes a meter cam leg, a knotter armature rotatable relative to the meter cam leg between a coupled condition and a decoupled condition, and an interference mechanism. The interference mechanism is translatable between an interference position in which the interference mechanism prevents the knotter armature from rotating relative to the meter cam leg and secures the knotter armature in the coupled condition, and a release position in which the interference mechanism allows the knotter armature to rotate relative to the meter cam leg to the decoupled condition. The interference mechanism is operable to shift the knotter armature to the decoupled condition when in the release position. The knotter armature is operable to shift the clutch to the engaged condition when the knotter armature is shifted to the decoupled condition and the trip cam assembly is in the metering condition.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of the embodiments disclosed therein. It should be understood that each figure depicts a particular aspect of the disclosed embodiments. Further, wherever possible, the following description refers to the reference numerals included in the following figures, in which features depicted in multiple figures are designated with consistent reference numerals.

FIG. 1 is a fragmentary side elevation of a baler constructed in accordance with a preferred embodiment of the present invention;

FIG. 2 is a perspective of the bale binding mechanism shown in FIG. 1;

FIG. 3 is a side elevation of the bale binding mechanism shown in FIG. 2, showing a trip arm assembly in a coupled position;

FIG. 4 is a side elevation of the bale binding mechanism shown in FIG. 2, showing the trip arm assembly in a decoupled position;

FIG. 5 is a perspective of the trip arm assembly shown in FIGS. 3 and 4, shown in the coupled position;

FIG. 6 is a side elevation of a first side of the trip arm assembly shown in FIG. 5, shown in the coupled position;

FIG. 7 is a side elevation of a second side of the trip arm assembly shown in FIG. 5, shown in the coupled position;

FIG. 8 is an end elevation of the trip arm assembly shown in FIG. 5, shown in the coupled position; and

FIG. 9 is a side elevation of the second side of the trip arm assembly shown in FIG. 5 but shown in the decoupled position.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein. While the drawings do not necessarily provide exact dimensions or tolerances for the illustrated components or structures, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

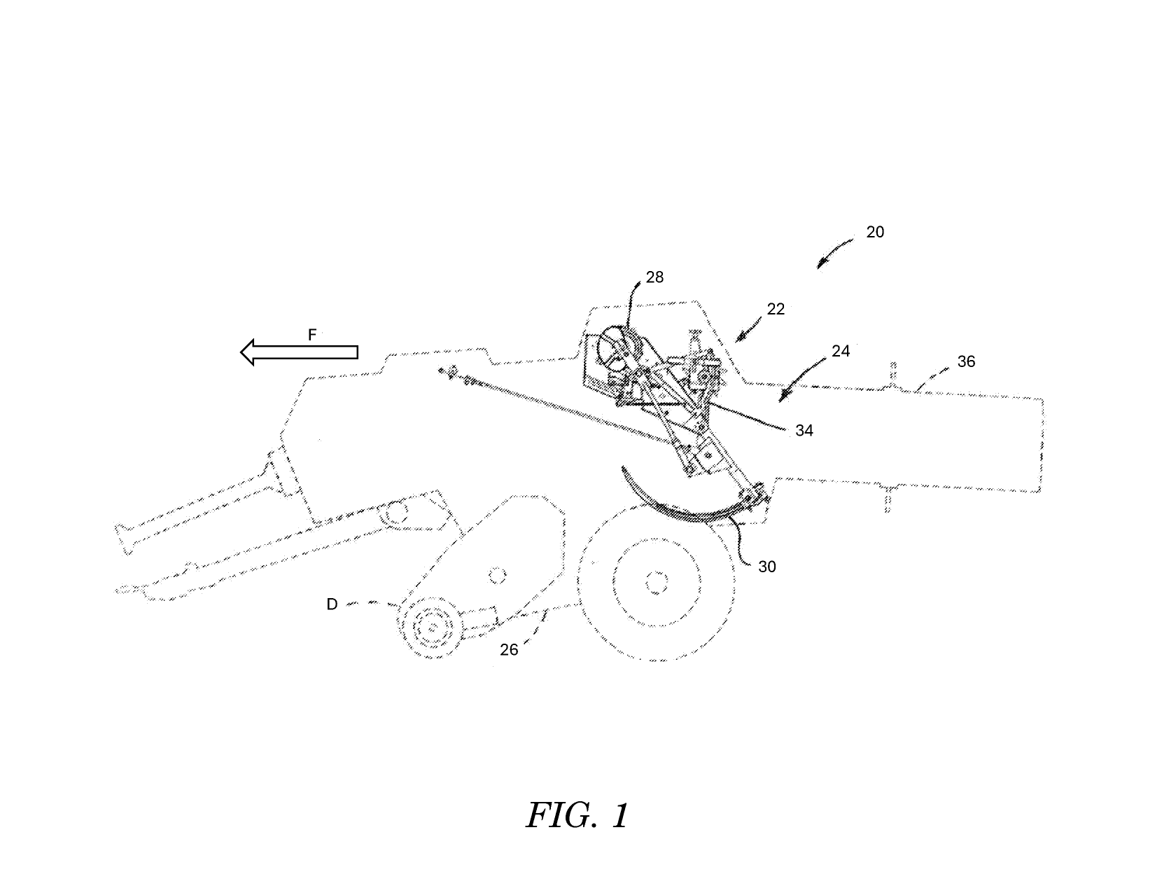

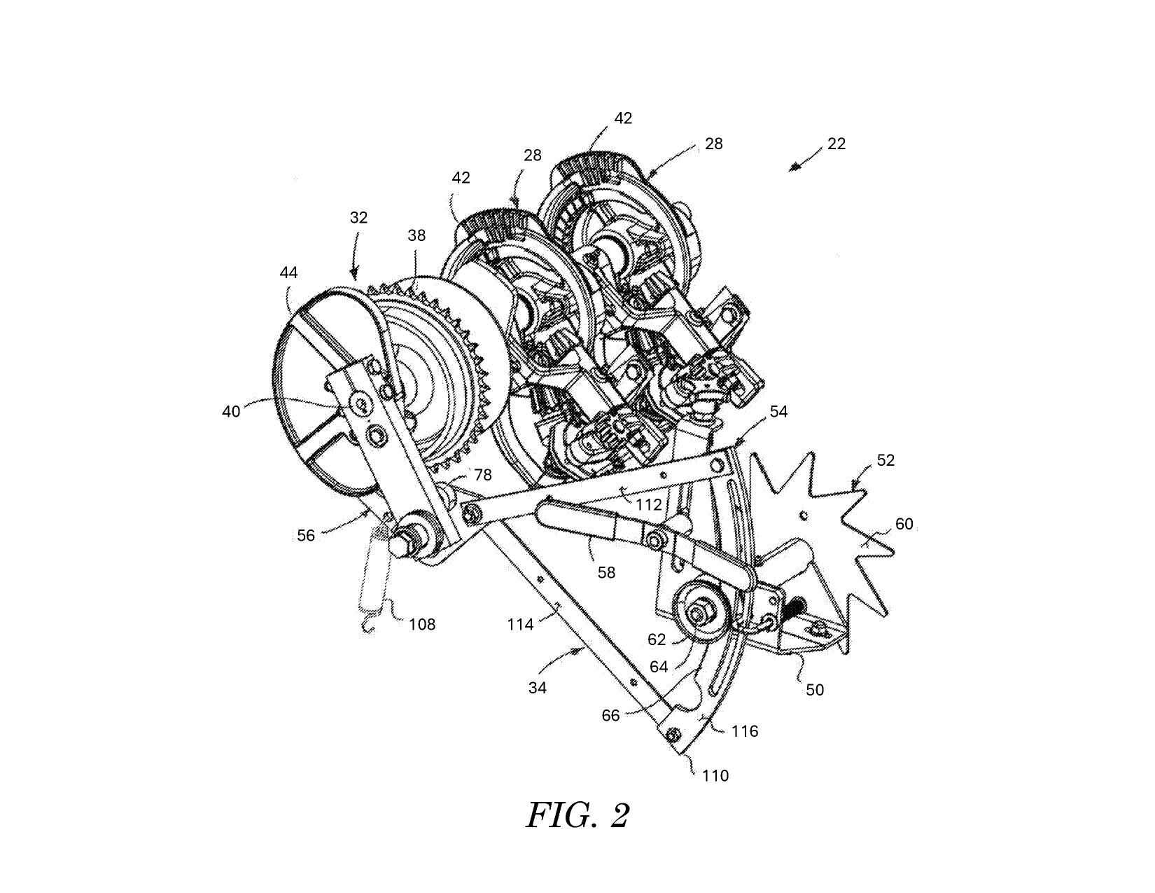

Turning to FIGS. 1 and 2, an agricultural baler 20, which may be configured to collect severed crop material (not shown) and form a series of bales (not shown) from the severed crop material, is depicted. The baler 20 may be advanced along a field to collect the severed crop material. In an example, the baler 20 may be generally towed by a powered tractor (not shown), or other self-powered vehicle, to be advanced in a forward direction F along a windrow of the severed crop material. As the baler 20 is advanced, a baler pickup device D of the baler 20 collects the windrow of the severed crop material and channels the material into a baling chamber 24 defined at least in part by a baler chassis 26.

The baler 20 may include a bale binding mechanism 22 configured to secure strands of binding material (not shown), such as twine, around a bale of the severed crop material. In the example embodiment, the bale binding mechanism 22 may include one or more knotter mechanisms 28, a needle assembly 30, a clutch assembly 32, and a tie trip mechanism 34 (see FIGS. 1-4).

The baler chassis 26 may be configured to support the baler pickup device D, the bale binding mechanism 22, and other operating components. The baler chassis 26 may include, among other things, a baler frame 36. The baler frame 36 may present the baling chamber 24. The baler frame 36 may be conventional and may include a series of fore-and-aft extending frame members (not shown). The fore-and-aft extending frame members may at least partly define the baling chamber 24 and may be configured to channel the severed crop material through the baling chamber 24 as the material is formed into bales (not shown). In the example embodiment, the baler frame 36 may also operably support the knotter mechanisms 28, needle assembly 30, and tie trip mechanism 34.

As a bale is formed within the baling chamber 24, strands of twine (not shown) may be extended and secured around the bale. The bales may be generally formed as the material moves in a rearward direction and directed rearwardly out of the baler 20. The baling chamber 24 may extend fore-and-aft to permit the bales to be formed and shifted rearwardly.

Turning to FIGS. 2-4, the one or more knotter mechanisms 28 may be configured to be driven by a drive sprocket 38 for binding bales in the baling chamber 24. Additionally, a cam wheel 44, which may be part of the needle assembly 30, may be configured to be driven by the drive sprocket 38. The drive sprocket 38 may be powered by a chain drive (not shown). The drive sprocket 38, the cam wheel 44, and the knotter mechanisms 28 may be coupled to a drive shaft 40 supported by the chassis 26. The knotter mechanisms 28 may include respective knotter heads 42 (see FIG. 2). Each knotter head 42 may be driven by the drive shaft 40 and cooperate with the needle assembly 30 to form at least one knot in respective strands of twine during a bale tie cycle. The drive sprocket 38 may be journaled on the drive shaft 40 and may be configured to rotate relative to the drive shaft 40 when the baler 20 is not performing a bale tie cycle. The cam wheel 44 may be configured to rotate a single revolution with the drive shaft 40 during a bale tie cycle. As described below, the bale tie cycle is initiated when the clutch assembly 32 is engaged.

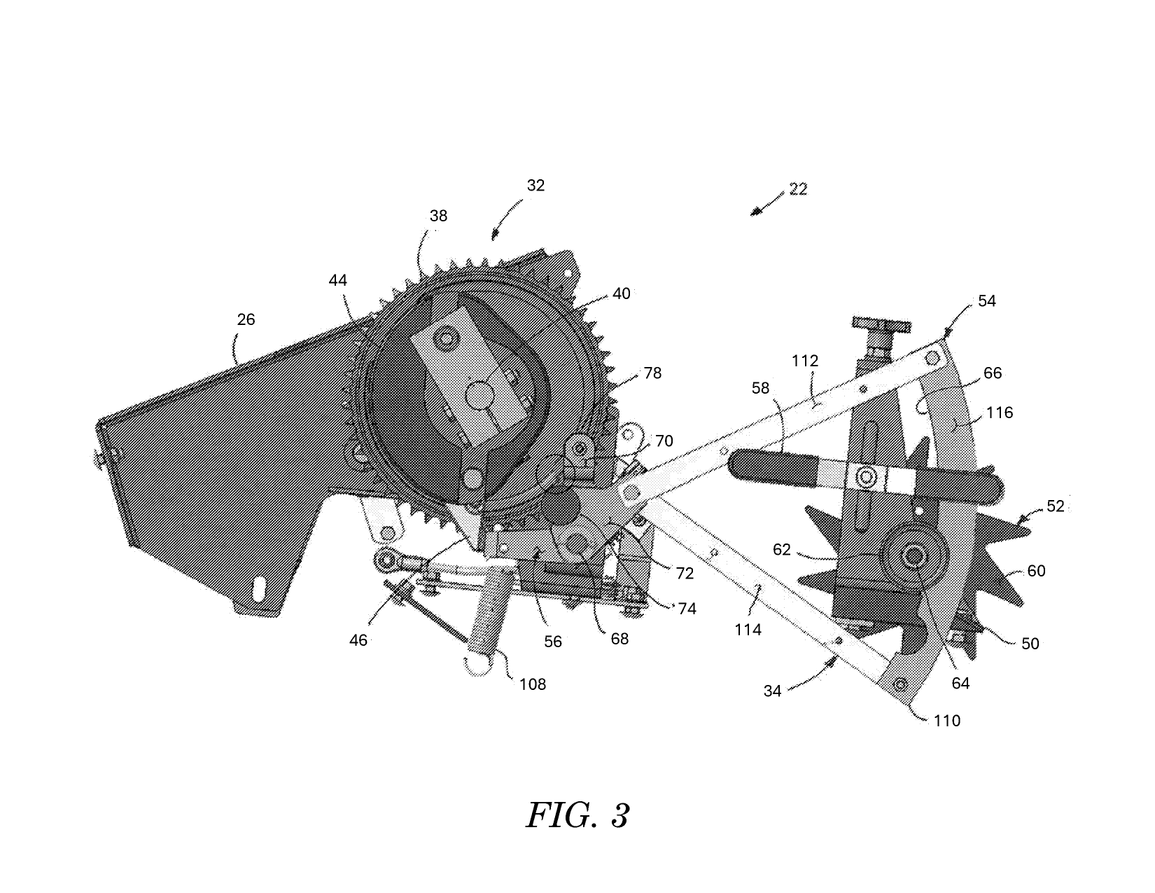

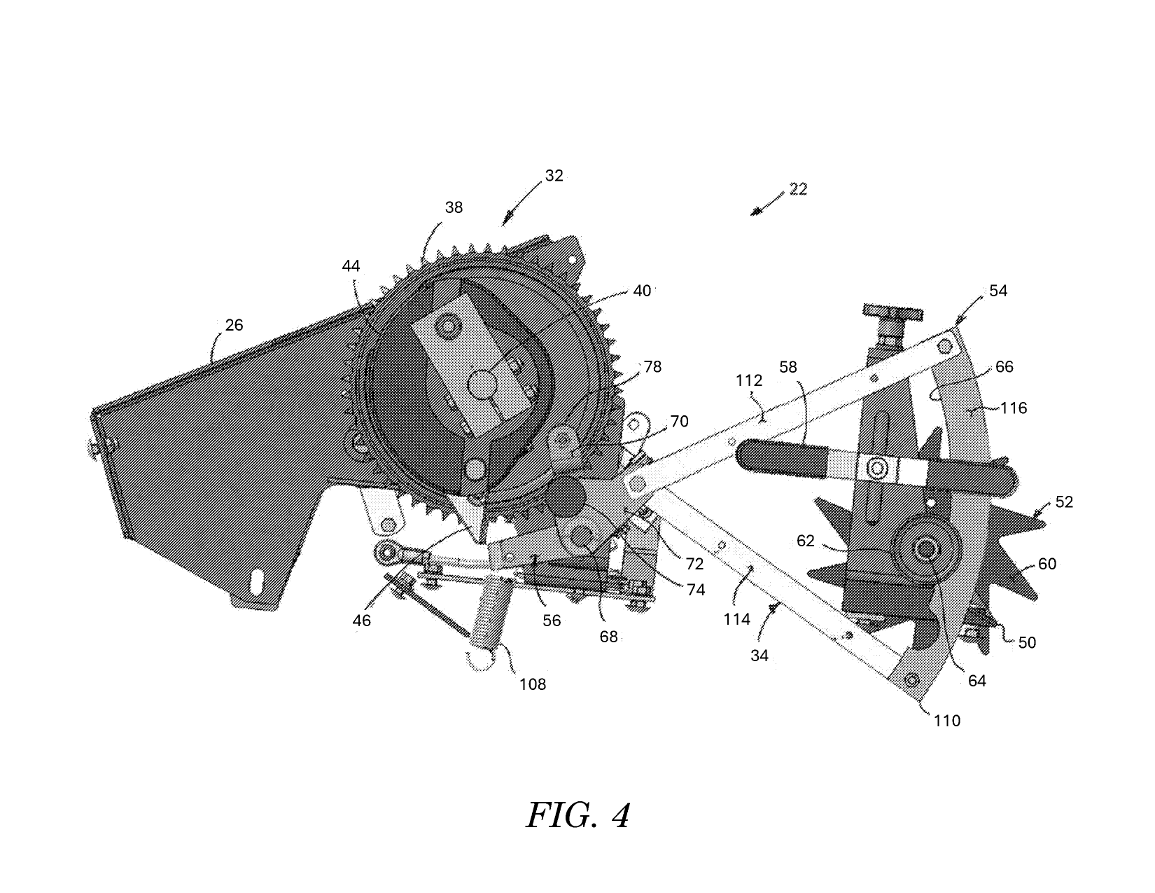

Turning to FIGS. 3 and 4, the clutch assembly 32 may be configured to initiate a bale tie cycle and transmit driving power from the drive shaft 40 to the needle assembly 30. The clutch assembly 32 may include a clutch arm 46. The clutch arm 46 may be pivotally mounted relative to the cam wheel 44, which may permit rotation of the clutch assembly 32 between an engaged condition, in which the clutch assembly 32 may drivingly interconnect to the drive shaft 40, and a disengaged condition, in which the clutch assembly 32 may be drivingly disengaged from the drive shaft 40 to prevent the drive shaft 40 from driving the needle assembly 30.

In the engaged condition (not shown), the clutch arm 46 may be shifted into engagement with the drive sprocket 38. With the clutch arm 46 and drive sprocket 38 engaged with each other, the clutch assembly 32 may be configured to transmit driving torque from the sprocket 38 to the cam wheel 44. In turn, the driving torque is transmitted to the knotter mechanisms 28 and the needle assembly 30 for performing a bale tie cycle.

In the disengaged condition, the clutch assembly 32 may be rotated from the engaged condition so that the clutch arm 46 may be spaced and disengaged from the drive sprocket 38. With the clutch assembly 32 disengaged, the clutch assembly 32 may permit the drive sprocket 38 to spin freely relative to the drive shaft 40.

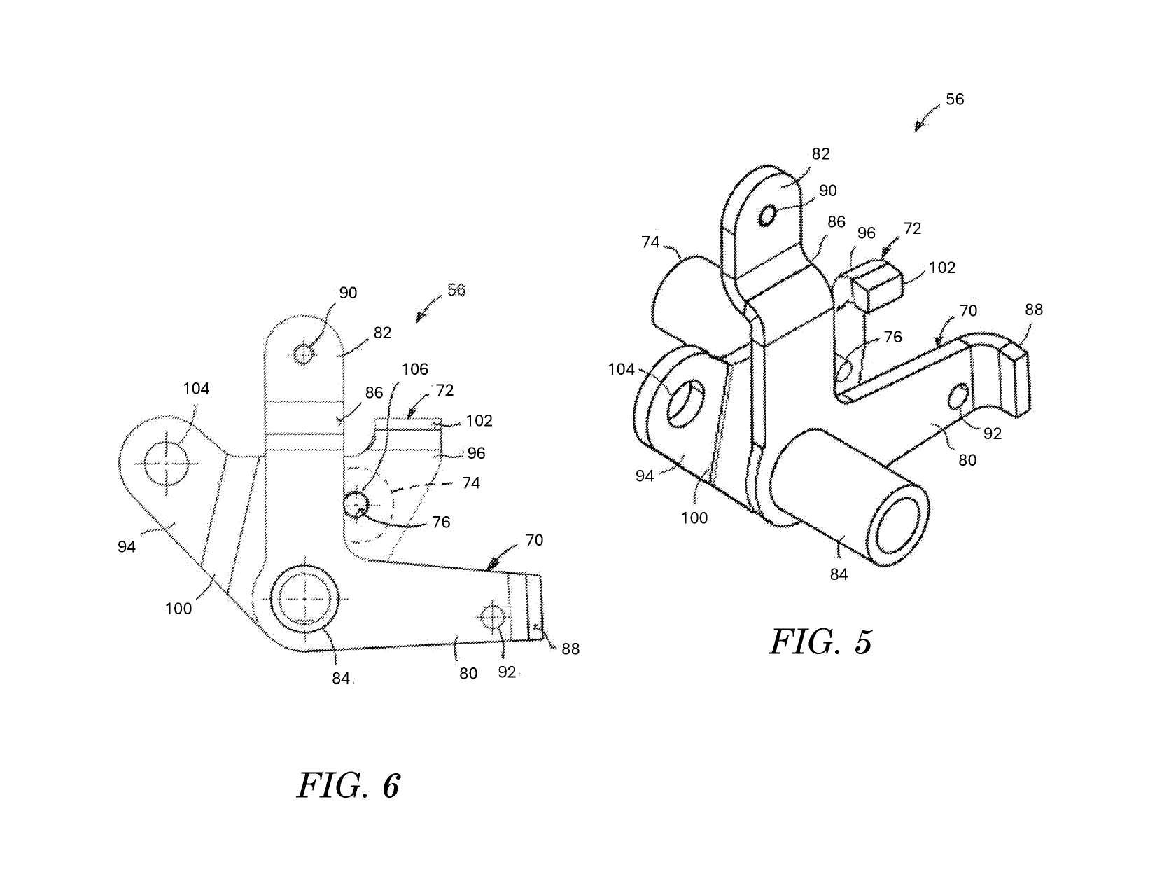

The tie trip mechanism 34 may be operable to control a size of the bale produced by the bale binding mechanism 22. For example, the tie trip mechanism 34 may be adjustable so that an operator can set a desired bale length. The tie trip mechanism 34 may include, among other things, a support 50, a drive 52, a trip cam assembly 54, a trip arm assembly 56, and a bale size adjuster 58 (see FIG. 5).

In the example embodiment, the trip cam assembly 54 may include a frame 110. The frame 110 may include a pair of legs 112, 114 and a cam body 116. The cam body 116 may extend between first ends of the legs 112, 114 (see FIGS. 2-4). Second ends of the legs 112, 114 may be pivotally attached to the trip arm assembly 56. In the example embodiment, the legs 112, 114 may have a fixed length and be generally formed from flat stock material, such as flat bar stock.

The depicted support 50 may be configured to position various components of the tie trip mechanism 34 for trip mechanism operation. The drive 52 may be operable to drive the trip cam assembly 54 for producing the desired bale length. The drive 52 may include, for example, a powered star wheel 60, a drive wheel 62, and a shaft 64 that may drivingly connect the wheels 60, 62. The star wheel 60 may be of conventional design and may include a plurality of large teeth configured to engage the bale as the bale passes along the baling chamber 24.

The drive wheel 62 may be operable to shift the trip cam assembly 54 (during baler operation) between a metering condition associated with disengagement of the clutch 32 and a tripped condition associated with engagement of the clutch 32, when the trip arm assembly 56 is in a coupled condition. For example, the drive wheel 62 may include a metering gear (not shown) configured to engage a toothed edge surface 66 of the trip cam assembly 54. As a bale passes along the baling chamber 24, the star wheel 60 may be rotated by the bale, which causes the drive wheel 62 to rotate. As the drive wheel 62 rotates, the engagement of the metering gear with the toothed edge surface 66 of the trip cam assembly 54 may produce a corresponding movement of the trip cam assembly 54.

The trip arm assembly 56 may be shiftable to cause engagement and disengagement of the clutch assembly 32. For example, the trip arm assembly 56 may be shiftable between a decoupled position (see FIG. 4) associated with engagement of the clutch assembly 32 and a coupled position (see FIG. 3) associated with disengagement of the clutch assembly 32. As explained in detail herein, the trip arm assembly 56 may be shiftable between the decoupled condition and coupled condition irrespective of the trip cam assembly 54 condition.

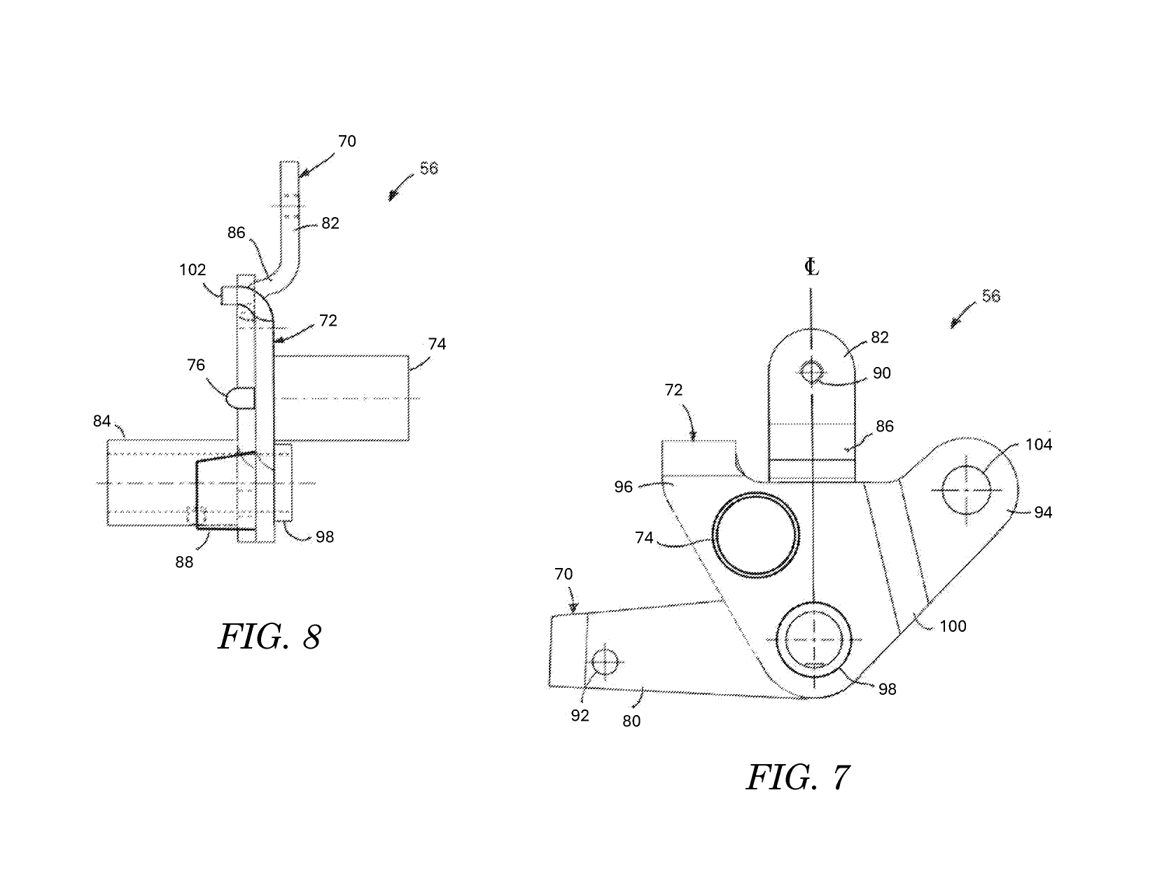

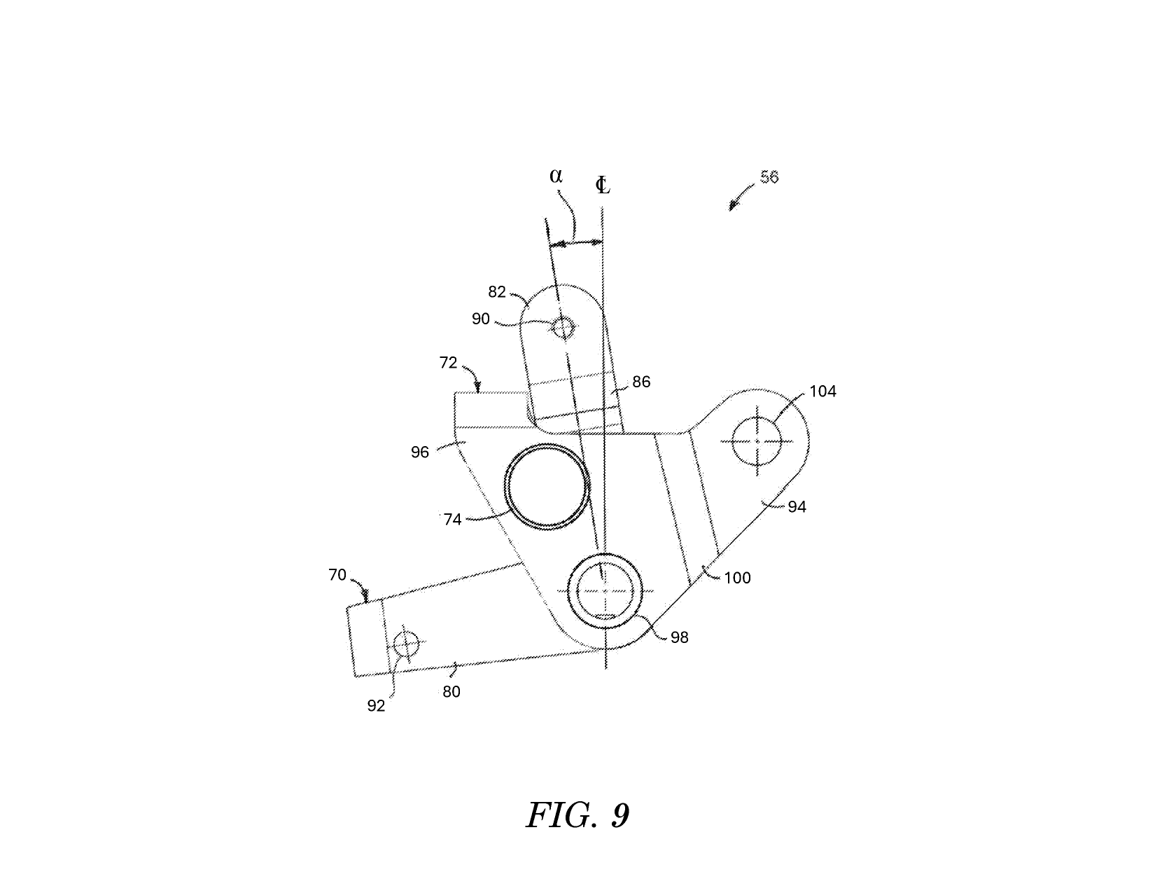

Referring to FIGS. 3-9, the trip arm assembly 56 may include a knotter armature 70, a meter cam leg 72, a releasing mechanism 74, and an interference mechanism 76. In the example embodiment, the knotter armature 70 may be rotatably coupled to the meter cam leg 72 such that the knotter armature 70 may be rotatable relative to the meter cam leg 72. The releasing mechanism 74 may be operatively coupled to the interference mechanism 76 such that the releasing mechanism 74 may translate the interference mechanism 76 between an interference position (i.e., the coupled condition, see FIGS. 6-8), in which the interference mechanism 76 prevents the knotter armature 70 from rotating relative to the meter cam leg 72, and a release position (, i.e., the decoupled condition, see FIG. 9), in which the interference mechanism 76 allows the knotter armature 70 to rotate relative to the meter cam leg 72. As shown in FIG. 9, in the release position, the knotter armature 70 may rotate an angle α relative to a vertical center line (see FIG. 7). In an embodiment, the angle α may be in a range between and including about five degrees (5°) and about fifteen degrees (15°), although it is contemplated that the angle α may be any angle that enables the trip arm assembly 56 to function as described herein.

In the example, referring to FIGS. 2-4, the trip arm assembly 56 may be pivotally attached relative to the chassis 26 at a pivot joint 68. The trip arm assembly 56 may include a cam roller 78 rotatably supported by the knotter armature 70 (see FIGS. 3, 4). The cam roller 78 may be configured to engage the cam wheel 44 during a bale tie cycle.

Referring to FIGS. 5-9, the knotter armature 70 may include a generally L-shaped body. The L-shaped body may have arm segments 80 and 82 that extend away from a central pivot portion having a pivot sleeve 84. The pivot sleeve 84 may be a hollow cylindrical sleeve configured to receive a fastener therethrough to facilitate pivotally attaching the knotter armature 70 relative to the chassis 26 at the pivot joint 68 (see FIGS. 3, 4). A distal end of the arm segment 80, relative to the pivot sleeve 84, may be configured with an offset bend 86 to shift a portion of the distal end out of plane with the central pivot portion. The offset bend 86 may be configured to facilitate aligning the cam roller 78, which may be rotatably supported at the distal end of the arm segment 80, with the cam wheel 44. A distal end of the arm segment 82, relative to the pivot sleeve 84, may include a flange 88 operable as a stop configured to releasably contact the clutch assembly 32, as described further herein. In the example, the flange 88 may extend at a normal angle relative to the arm segment 82, in an opposite direction of the offset bend 86.

The distal end of the arm segment 82 may include an aperture 90 for mounting the cam roller 78 thereto. In an example, the aperture 90 may include a threaded hole for receiving a threaded fastener (not shown). In other examples, the aperture 90 may include any type of opening, hole, or gap that facilitates mounting the cam roller 78 to the arm segment 82.

The distal end of the arm segment 80 may include an attachment member 92 for attaching a spring 108 (see FIGS. 3, 4) thereto, as described further below. In an example, the attachment member 92 may include an aperture or hole for receiving a hooked end of an extension spring. In other examples, the attachment member 92 may include any type of attachment member, such as a pin or peg, which facilitates attaching the spring 108 to the arm segment 80.

The meter cam leg 72 may include a generally V-shaped body. The V-shaped body may have arm segments 94 and 96 that extend away from a generally central pivot portion having a pivot sleeve 98. The pivot sleeve 98 may be a hollow cylindrical sleeve configured to receive a fastener therethrough to facilitate pivotally attaching the meter cam leg 72 relative to the chassis 26 at the pivot joint 68 (see FIGS. 3, 4). In the example, the pivot sleeve 98 may be generally aligned with the pivot sleeve 84 of the knotter armature 70 to form part of the trip arm assembly 56. A single fastening component may be extended through the pivot sleeves 84 and 98 to pivotally attach the trip arm assembly 56 relative to the chassis 26. The pivot sleeves 84 and 98 allow both the knotter armature 70 and meter cam leg 72 to pivot relative to the chassis 26, either individually or jointly.

A distal end of the arm segment 94, relative to the pivot sleeve 98, may be configured with an offset bend 100 to shift a portion of the distal end out of plane with the central pivot portion. The offset bend 100 may be configured to facilitate limiting an amount of rotation of the knotter armature 70 relative to the meter cam leg 72. A distal end of the arm segment 96, relative to the pivot sleeve 98, may include a flange 102 operable as a stop configured to contact the knotter armature 70. In the example, the flange 102 may extend at a normal angle relative to the arm segment 96, in the same direction of the offset bend 100. In this manner, the arm segment 82 of the knotter armature 70 may nest between the offset bend 100 and the flange 102, wherein rotation of the knotter armature 70 relative to the meter cam leg 72 is limited thereby.

The distal end of the arm segment 94 may include an attachment member 104 for attaching the meter cam leg 72 to the trip cam assembly 54. In an example, the attachment member 104 may include an aperture or hole for receiving a fastener (not shown) therethrough. In other examples, the attachment member 104 may include any type of attachment member, such as a threaded pin or peg, which facilitates attaching the trip cam assembly 54 to the arm segment 94.

The arm segment 96 may include an aperture 106 for receiving the interference mechanism 76 therethrough. The aperture 106 may be positioned proximate the arm segment 82 of the knotter armature 70 to facilitate the interference mechanism 76 securing the knotter armature 70 such that the trip arm assembly 56 is in the coupled condition (see FIG. 3).

In an embodiment, the interference mechanism 76 may include a slide pin configured to slide axially through the aperture 106 of the meter cam leg 72 between the interference position (i.e., the coupled condition, see FIGS. 6-8) and the release position (i.e., the decoupled condition, see FIG. 9). The interference mechanism 76 may include a generally cylindrical pin or bolt. In an embodiment, an end of the interference mechanism 76 may be domed or chamfered.

In the interference position, the interference mechanism 76 may be configured to prevent the knotter armature 70 from rotating relative to the meter cam leg 72. Specifically, in the interference position, the interference mechanism 76 may extend through the aperture 106 and contact the arm segment 82 of the knotter armature 70, for example, along an edge of the arm segment 82 opposite the offset bend 100. In the release position, the interference mechanism 76 may be extracted axially into or back through the aperture 106 such that the interference mechanism 76 may not contact the arm segment 82 of the knotter armature 70.

As discussed above, the releasing mechanism 74 may be coupled to the interference mechanism 76 to facilitate translating the interference mechanism 76 between the interference position and the release position. In an embodiment, the releasing mechanism 74 may include a manual grasping member, such has a handle, split ring, carabiner, eye bolt, hook, pull strap, and the like, coupled to the interference mechanism 76 to facilitate manually translating of the interference mechanism 76. In another embodiment, the releasing mechanism 74 may include a linear motion device, such as a linear solenoid, linear actuator, and the like. The linear motion device may be configured to move the interference mechanism 76 axially between an extended position (i.e., the interference position) and a retracted position (i.e., the release position). In such an embodiment, the linear motion device may be mechanically or electrically powered and may be manually or automatically activated. Automatic activation may be triggered by a controller coupled to the baler 20 when a bale is formed to a desired size, as indicated by one or more sensors coupled to the baler 20 and controller and configured to sense a bale size.

In some examples, the releasing mechanism 74 may include a biasing element (not shown) configured to urge the interference mechanism 76 toward the interference position after activation of the releasing mechanism 74. This may facilitate shifting the trip arm assembly 56 back into the coupled condition (see FIGS. 6-8), as discussed below.

Referring back to FIGS. 3 and 4, as discussed above, the trip arm assembly 56 may be pivotally attached relative to the chassis 26 at the pivot joint 68. The flange 88 of the knotter armature 70 may be configured to operate as a stop to releasably contact the clutch assembly 32. For example, the flange 88 may contact the clutch assembly 32, and more particularly the clutch arm 46, in a clutch contact position and hold the clutch assembly 32 in the disengaged clutch condition (see FIG. 3). The disengaged clutch condition may correspond to the coupled condition of the trip arm assembly 56. Additionally, the flange 88 may be shiftable out of contact with the clutch assembly 32 (see FIG. 4) so that the clutch assembly 32 may shift into the engaged clutch condition. Again, engagement of the clutch assembly 32 preferably corresponds to the decoupled condition of the trip arm assembly 56.

The spring 108 may be attached to the trip arm assembly 56, and more particularly, to the attachment member 92 of the knotter armature 70. The spring 108 may be configured to urge the knotter armature 70 out of the clutch contact position to permit disengagement of the clutch assembly 32 (see FIG. 4) and initiate a bale tie cycle.

In the example embodiment, when an operator or controller determines that a bale tie cycle is to be performed, the operator or controller may activate the releasing mechanism 74 to translate the interference mechanism 76 from the interference position to the release position. When the interference mechanism 76 translates to the release position, the spring 108 may pull the knotter armature 70 of the trip arm assembly 56 out of the clutch contact position, shifting the trip arm assembly 56 to the decoupled condition. As depicted in FIG. 4, the knotter armature 70 may be shifted out of the clutch contact position while the trip cam assembly 54 is in the metering condition and holds the meter cam leg 72 in position. Thus, a bale tie cycle may be performed at any desirable point during baling.

During the bale tie cycle, the knotter armature 70 may be returned to the clutch contact position by the cam wheel 44, which may engage the cam roller 78 to pivot the knotter armature 70 back to the clutch contact position. More particularly, the cam wheel 44 may rotate the knotter armature 70 relative to the meter cam leg 72. The cam wheel 44 may rotate the knotter armature 70 back into the coupled condition such that the releasing mechanism 74 (via the biasing element, as discussed above) may automatically translate the interference mechanism 76 into the interference position. Such movement of the trip arm assembly 56 may shift the trip cam assembly 54 along a transverse direction so that the trip cam assembly 54 can return to an initial metering condition. For example, the trip cam assembly 54 may be shifted rearwardly to permit the drive wheel 62 to be moved into an initial position along the driven surface 66. As such, the trip arm assembly 56 may be automatically reset from the decoupled condition to the coupled condition.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

What is claimed is:

1. An agricultural baler comprising:
a drive shaft;
a clutch shiftable between an engaged condition in which the clutch drivingly interconnects to the drive shaft, and a disengaged condition in which the clutch is drivingly disengaged from the drive shaft; and
a tie trip mechanism comprising:
a trip cam assembly shiftable between a metering condition associated with the disengaged condition of the clutch and a tripped condition associated with the engaged condition of the clutch; and
a trip arm assembly coupled to the trip cam assembly, the trip arm assembly comprising:
a meter cam leg;
a knotter armature rotatable relative to the meter cam leg between a coupled condition and a decoupled condition; and
an interference mechanism translatable between an interference position in which the interference mechanism prevents the knotter armature from rotating relative to the meter cam leg and secures the knotter armature in the coupled condition, and a release position in which the interference mechanism allows the knotter armature to rotate relative to the meter cam leg to the decoupled condition,
the interference mechanism operable to shift the knotter armature to the decoupled condition when in the release position,
the knotter armature operable to shift the clutch to the engaged condition when the knotter armature is shifted to the decoupled condition and the trip cam assembly is in the metering condition.

2. The agricultural baler in accordance with claim 1,
the trip arm assembly comprising a releasing mechanism coupled to the interference mechanism.

3. The agricultural baler in accordance with claim 2,
the releasing mechanism operable to translate the interference mechanism between the interference position and the release position.

4. The agricultural baler in accordance with claim 3,
the releasing mechanism comprising one of a manual grasping member and a linear motion device.

5. The agricultural baler in accordance with claim 4,
the manual grasping member comprising one of the following: a handle, a split ring, a carabiner, an eye bolt, a hook, and a pull strap.

6. The agricultural baler in accordance with claim 4,
the linear motion device comprising one of the following: a linear solenoid and a linear actuator.

7. The agricultural baler in accordance with claim 4, wherein the releasing mechanism may be activated manually by an operator of the agricultural baler.

8. The agricultural baler in accordance with claim 4, further comprising a controller and one or more sensors coupled to the controller,
wherein the releasing mechanism may be activated automatically by a controller.

9. The agricultural baler in accordance with claim 1,
the meter cam leg comprising a V-shaped body having a first central pivot portion, a first arm segment, and a second arm segment,
the first central pivot portion comprising a first pivot sleeve,
the first and second arm segments extending away from the first central pivot portion,
a first distal end of the first arm segment, relative to the first central pivot portion, being configured with a first offset bend, thereby shifting a portion of the first distal end out of plane with the first central pivot portion,
a second distal end of the second arm segment, relative to the first central pivot portion, including a first flange extending at a normal angle relative to the second arm segment, in a same direction as the first offset bend.

10. The agricultural baler in accordance with claim 9,
the knotter armature comprising an L-shaped body having a second central pivot portion, a third arm segment, and a fourth arm segment,
the second central pivot portion comprising a second pivot sleeve,
the third and fourth arm segments extending away from the second central pivot portion,
a third distal end of the third arm segment, relative to the second central pivot portion, being configured with a second offset bend, thereby shifting a portion of the third distal end out of plane with the second central pivot portion,
a fourth distal end of the fourth arm segment, relative to the second central pivot portion, including a second flange extending at a normal angle relative to the fourth arm segment, in an opposite direction of the second offset bend.

11. The agricultural baler in accordance with claim 10,
the trip arm assembly having the first pivot sleeve of the meter cam leg aligned with the second pivot sleeve of the knotter armature,
wherein one of the third or fourth arm segments of the knotter armature is nested between the first offset bend and first flange of the meter cam leg,
wherein the first offset bend and first flange of the meter cam leg limit a rotation angle of the knotter armature relative to the meter cam leg.

12. The agricultural baler in accordance with claim 1,
the meter cam leg comprising an aperture defined therein for receiving at least a portion of the interference mechanism therethrough,
the aperture being positioned to facilitate the interference mechanism securing the knotter armature in the coupled condition.
